(19) United States
(12) Patent Application Publication
(10) Pub. No.: US 2009/0303326 A1
(43) Pub. Date: Dec. 10, 2009

(54) VIDEO DOCUMENTATION OF VEHICLE SERVICES PROVIDED

(76) Inventor: John DeCosmo, Glenview, IL (US)

Correspondence Address: NIXON PEABODY, LLP, 300 S. Riverside Plaza, 16th Floor, CHICAGO, IL, 60606, US

(21) Appl. No.: 12/478,566

(22) Filed: Jun. 4, 2009

Related U.S. Application Data
(60) Provisional application No. 61/130,929, filed on Jun. 4, 2008.

(51) Int. Cl. H04N 7/18

(52) U.S. Cl. 348/148

(57) ABSTRACT

A method of providing a vehicle service event includes providing at least one vehicle service area at a service facility. The at least one service area is configured to provide for the performance of a service event on a customer vehicle. At least one video camera is positioned with respect to the service area and the customer's vehicle to provide for capturing images of the customer vehicle. The method further includes performing a service event on the customer vehicle and while performing the service event, capturing images of the customer vehicle with the video camera. The method additionally includes receiving the captured images in a recording device, recording the captured images onto a electronic storage media with the recording device, and providing the electronic storage media to the customer.

### TECHNICAL FIELD

The following disclosure relates generally to the performance of vehicle repair or maintenance services. More specifically, the following disclosure relates to a system and a method for ensuring honest performance of vehicle repair and maintenance services on a specific customer's vehicle.

### BACKGROUND

According to the Consumer Federation of America, auto repair problems make up one of the largest groups of consumer complaints each year. While the majority of auto service shops are honest and reliable, there exits a pervasive public perception that many shops and mechanics are dishonest.

It is relatively easy for an unethical mechanic to convince customers that unnecessary repairs or services are needed because the average person is largely uneducated about automobiles. Even automobile savvy customers can be defrauded because without actually witnessing the services firsthand, customers have no way of knowing what mechanics actually did. One scheme employed by dishonest mechanics involves charging customers for parts that were never used, labor hours that were not required, or services that were never performed. In another scheme, dishonest mechanics intentionally cause damage while performing routine maintenance services.

The public's general lack of knowledge and inability to witness the services performed allows dishonest mechanics to get away with fraud and causes honest mechanics to have to endure the general mistrust of their customers.

### SUMMARY

A system for providing vehicle service includes at least one vehicle service area at a service facility. The service area is configured to provide for the performance of service events on a customer vehicle. The system further includes at least one video camera positioned with respect to the service area and the customer vehicle to capture images of the customer vehicle while at least one service event is performed. The system also includes a recording device that is configured to record the images onto an electronic storage media, which is provided to the customer for subsequent viewing of the images recorded thereon.

A method of providing a vehicle service event includes providing at least one vehicle service area at a service facility. The at least one service area is configured to provide for the performance of a service event on a customer vehicle. At least one video camera is positioned with respect to the service area and the customer's vehicle to provide for capturing images of the customer vehicle. The method further includes performing a service event on the customer vehicle and while performing the service event, capturing images of the customer vehicle with the video camera. The method additionally includes receiving the captured images in a recording device, recording the captured images onto a electronic storage media with the recording device, and providing the electronic storage media to the customer.

The above summary is not intended to represent each embodiment or every aspect of the present invention. The detailed description and Figures will describe many of the embodiments and aspects of the present invention.

### BRIEF DESCRIPTION OF THE DRAWINGS

FIG. 1 is an illustration of a vehicle service area for performing a service event on a vehicle in accordance with some embodiments of the present invention.

FIG. 2 is a flow diagram of a vehicle service system in accordance with some embodiments of the present invention.

FIG. 3 is a flow diagram of a vehicle service system in accordance with other embodiments of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention.

### DETAILED DESCRIPTION OF ILLUSTRATED EMBODIMENTS

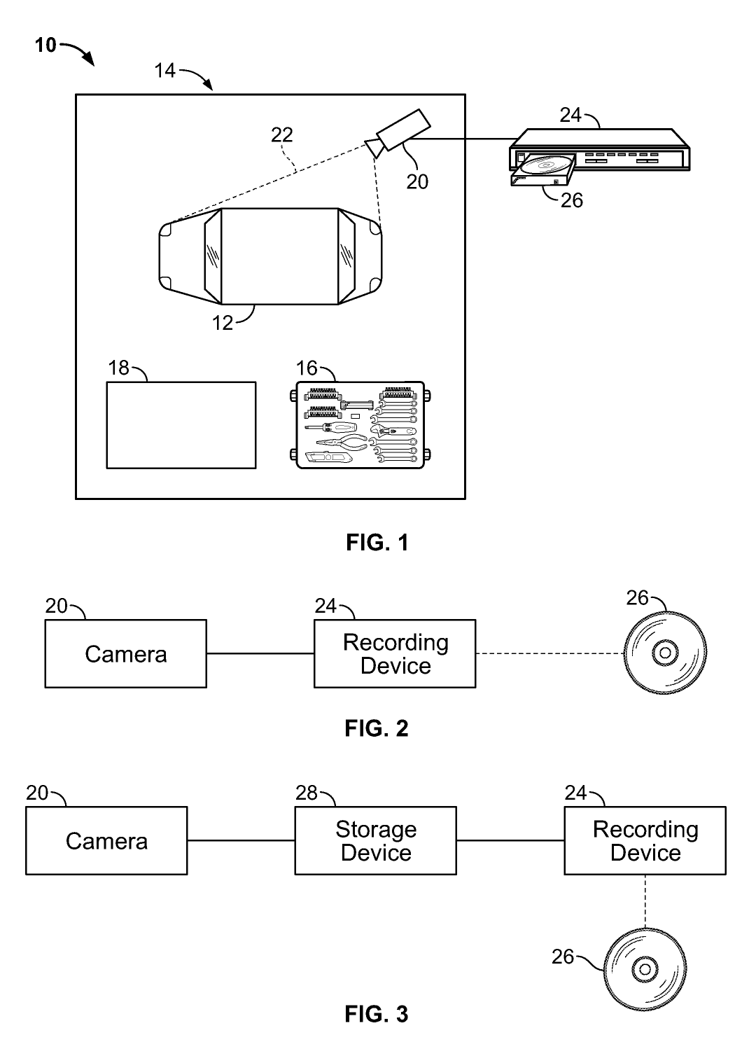

FIG. 1 illustrates a system 10 for performing service events on a vehicle 12 according to one embodiment of the present invention. A service shop has at least one service area 14 that is configured to provide for the performance of service events on a customer's vehicle 12. The service events may be any vehicle related services including, but not limited to, maintenance services, repair services, installation services, modification services, combinations thereof, or the like. It is contemplated that any type of vehicle 12 may be serviced according to the concepts disclosed herein such as, for example, automobiles, boats, motorcycles, waverunners, or the like. The service area 14 may contain any of the tools 16 or equipment 18 necessary for performing the relevant service events on the vehicles 12. For example, the service area 14 may include a lift, a workman's bench, rolling tool kit, and/or the like.

As illustrated in FIG. 1, a customer's vehicle 12 is positioned within the service area 14 for the service event to be performed on the vehicle 12. A video camera 20 is positioned within the service area 14 such that the customer's vehicle 12 is within the field of view 22 of the video camera 20. While the video camera 20 illustrated in FIG. 1 is mounted on the ceiling of the service area 14, the video camera 20 may alternatively be mounted on or within any other suitable supporting structure such as, for example, a side wall, the floor, or a camera stand (e.g., a tripod).

Desirably, the video camera 20 may be positioned within the service area 14 in a manner that best captures images of the specific portion of the customer's vehicle 12 on which the service event will be performed. According to some embodiments, the video camera 20 is mounted in an elevated position to capture the entire vehicle 12. According to other embodiments, the video camera 20 is mounted on a bracket configured to move, tilt, and swivel in all directions. Thus, a mechanic may manually move the bracket to aim the video camera 20 as needed to best capture the images of the service event. According to still other embodiments, multiple video cameras 20 may be disposed throughout the service area 14. The mechanic selects and activates the video camera 20 best positioned to capture images of the service event performed on the customer's vehicle 12. In some instances, the mechanic may switch video cameras 20 (i.e., deactivate one camera and activate another) during the performance of the service event. Optionally, a monitor or other video output device may be coupled to the video camera 20 to aid in the aligning the field of view 22 of the video camera 20 with the portion of the vehicle 12 upon which the service event will be performed. It is contemplated that the video camera operator may further utilize common camera functions such as, for example, zoom to better align the field of view 22 of the video camera 20. It is further contemplated that any combination of the above described means or any other suitable means may be employed for mounting, positioning, aligning, and/or activating/deactivating the at least one video camera 20.

According to the embodiments illustrated in FIG. 1 and FIG. 2, the video camera 20 is directly connected to a recording device 24 by any suitable means for transmitting the images from the video camera 20 to the recording device 24. For example, the video camera 20 may be connected to the recording device 24 by wired connections including, but not limited to, composite video, RGB component video, YPbPr component video, S-video, coaxial cable, SCART, D-Terminal, VGA, Display Port, HDMI, fiber optics, internet, Ethernet, combinations thereof, or the like. Alternatively, the video camera 20 may be wirelessly connected to the recording device 24 by any suitable near field or far field communications means such as, for example, Bluetooth, free space optics, radio frequency communications, combinations thereof, or the like.

The recording device 24 may comprise any suitable means for recording the images on a suitable form of electronic storage media 26 such as, for example, CD, DVD, Blu-ray Disc, 8 cm miniDVD, minidisk, flash memory, or the like. For example, the recording device 24 may be an optical disc recorder such as a standalone DVD or VCD (i.e., video CD) recorder. According to some embodiments, the recording device 24 may be disposed within the video camera 20. For example, the video camera 20 may be configured to record the captured images on a 8 cm miniDVD, which is compatible with most standard DVD players.

At the time of purchase, the customer may elect to pay an additional fee for the service event to be performed according to the system 10 and method described with respect to FIG. 1 and FIG. 2. Alternatively, performance of the service event according to the system 10 and the method of FIG. 1 and FIG. 2 may be automatically included in the purchase price of the service event. In either event, the customer provides his or her vehicle 12 to the mechanic or shop for servicing. The vehicle 12 is positioned within the service area 14 for performance of the service event on the vehicle 12. Prior to beginning the service event, the appropriate video camera 20 is selected (if there is more than one video camera 20) and positioned (if applicable) such that images of the service event will be captured within the field of view 22 of the video camera 20.

At the start of the service event, the mechanic activates the video camera 20 to begin capturing images. It is contemplated that the mechanic may activate the video camera 20 by any suitable means such as, for example, by depressing a play/record button on the video camera 20, remote activation, or a foot pedal located within the service area 14. During the service event or after the service event, the video camera 20 transmits the images to the recording device 24, which records the images to the electronic storage media 26 during or after the service event. Accordingly, the recording device 24 may be activated before or after the service event depending on whether the recording to electronic storage media 26 is performed during or after the service event.

According to some embodiments, the mechanic may deactivate the video camera 20 and/or the recording device 24 each time work is stopped and reactivate the video camera 20 and/or the recording device 24 each time work is resumed. In other embodiments, the video camera 20 and/or the recording device 24 may continuously run throughout the service event regardless of any work stoppages.

After the service event is completed, the video camera 20 is deactivated. If necessary (i.e., if the images were not transmitted during the service event), the images are transmitted to the recording device 24. The recording device 24 completes the recording of the images to the electronic storage media 26. At this time, the shop or mechanic may optionally add a label or customer identifier to the electronic storage media 26 or a casing in which the electronic storage media 26 is disposed. When the customer returns to pick up his or her vehicle 12, the mechanic provides the electronic storage media 26 to the customer. The customer may then view the images of the service event recorded on the electronic storage media 26 at their convenience on a suitable device such as, for example, a DVD player or a home computer.

After such viewing, the customer can rest assured that the service event was performed in an honest and trustworthy manner or discuss any concerns with the mechanic or shop. Further, the mechanic and shop will likely have generated goodwill with the customer by proving that the service event was performed in an honest and trustworthy manner.

According to an alternate embodiment illustrated in FIG. 3, the video camera 20 is directly connected by wired or wireless connection(s) to a storage device 28 such as, for example, a computer or a digital video recorder (hereinafter “DVR”). The storage device 28 includes a hard disk for storing the images received from the video camera 20. Optionally, the storage device 28 may further include software suitable to edit the images received from the video camera 20. Nonlimiting examples of editing functions include deleting dead time (i.e., gaps in time when no work was performed) or enhancing image quality. User input and output devices may be provided for facilitating the editing of the images. For example, a monitor, a mouse, and a keyboard may be coupled to a computer storage device 28 or a television and a remote control may be coupled to a DVR storage device 28. It is contemplated that when editing is performed on the images, an edited version and an unedited version may be recorded on the electronic storage media 26 to assure the customer that nothing dishonest occurred during edited portions of the images.

It is further contemplated that images may be time and date stamped to enable the customer to determine the duration of the service event. The customer may then compare the determined duration of the service event with the time charged for labor of the service event.

Advantageously, additional video feature(s) may be added to the electronic storage media 26 for educational, marketing, or entertainment purposes when a storage device 28 is included in the system 10. For example, each customer's DVD may include a short documentary generally explaining how cars are manufactured or a video clip providing the customer with preventive maintenance tips such as, for example, when and how to change the oil or rotate the tires. The additional videos provide the customer with a convenient instrument for learning or teaching the basics of automotives. These additional videos may prove especially attractive to parents who desire to educate their children about automotives or other vehicles. As an additional benefit, customers practicing the preventive tips may minimize the frequency of future maintenance and repair services or may be better prepared to diagnose future automotive issues. Generally, as a consumer's knowledge of automotives increases, the likelihood of a dishonest mechanic attempting or getting away with fraud decreases.

Further, the additional video features may comprise an advertisement highlighting services, parts, or gadgets offered for sale by the mechanic or shop. For example, each customer's DVD may include a video advertisement for remote starters offered for sale and installation by the shop or mechanic. The additional video features provide a unique opportunity for the shop or mechanic to upsell the customer by advertising additional products and services to the customer. The advertisements may be all the more effective when viewed immediately after or before a customer watches his or her own vehicle 12 serviced in an honest and trustworthy manner.

The storage device 28 is connected by wired or wireless communications to the recording device 24, which may comprise a standalone DVD recorder, a standalone CD recorder, a DVD or CD burner (i.e., a computer based drive), a USB port, or the like. According to some embodiments, the recording device 24 may be disposed within the storage device 28. For example, the recording device 24 may comprise a DVD burner drive disposed within a DVR or a personal computer.

The operation of the embodiment described with respect to FIG. 3 proceeds in much the same way as described previously with respect to FIG. 1 and FIG. 2. The customer solicits and/or purchases the service event, the vehicle 12 is positioned within the service area 14, the field of view 22 of the video camera(s) 20 are positioned with respect to the specific portion of the vehicle 12 on which the service event will be performed, and/or at least one video camera 20 is activated. During the service event or after the service event is performed, the video camera 20 transmits the images to the storage device 28, which stores the images in hard disk memory. The operator or mechanic may later access the images on the storage device 28 and optionally perform editing functions. The operator or mechanic may utilize software to select the images of the service event and any desired additional features to be recorded on the electronic storage media 26. The storage device 28 then transmits data relating to the images and the additional video features to the recording device 24, which records the same to the electronic storage media 26. The customer retrieves his or her vehicle 12, pays for the service event (if not previously paid for), and receives the electronic storage media 26. The customer may then view the service event and the optional additional video features at his or her own convenience on a suitable device. Again, the customer is assured that the service event was performed in an honest and trustworthy manner. The customer may further utilize the additional video features to learn about automotives or to teach others. The customer may also view an advertisement for a service or part and later return to the mechanic or shop to purchase that additional service or part.

It is contemplated that according to any of the embodiments previously described, audio may be provided with the images of the service event. The audio may be the actual audio from within the service area 14 captured by any suitable means such as, for example, a microphone disposed within the video camera 20 or a microphone worn by the mechanic. Providing audio to accompany the images may be advantageous because the customer will have a fuller appreciation for the service event being performed. To further enhance the educational experience of the viewing the service event, the mechanic may also provide commentary explaining the reasons certain problems arose, the reasons repairs are needed, and/or the tasks he is performing.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the invention, which is set forth in the following claims.

What is claimed is:

1. A system for providing vehicle service comprising:
at least one vehicle service area at a service facility, the service area being configured to provide for the performance of service events on a customer vehicle;
at least one video camera positioned with respect to the service area and the customer vehicle to capture images of the customer vehicle while at least one service event is performed; and
a recording device configured to record the images onto an electronic storage media, the electronic storage media being provided to the customer for subsequent viewing of the images recorded thereon.

2. The system of claim 1, wherein the recording device being in direct communication with the at least one video camera.

3. The system of claim 2, wherein the recording device is configured to record the images at substantially the same time as the images are captured by the video camera.

4. The system of claim 1, wherein said electronic storage media is a DVD.

5. The system of claim 1 further comprising a storage device configured to receive the images from the at least one video camera, to store the images received from the at least one video camera into memory, and to transmit the images from memory to the recording device.

6. The system of claim 5, wherein the video storage device is a computer.

7. The system of claim 5, wherein a plurality of additional video features are stored in the memory of the storage device, and at least one of the additional video features is recorded on the electronic storage media.

8. The system of claim 7, wherein the plurality of additional video features include at least one of an advertisement, a documentary, a preventive maintenance tip, and an instructional video.

9. The system of claim 5, wherein the storage device further comprises software for editing the images received from the video camera.

10. The system of claim 5, wherein the recording device is disposed within the storage device.

11. The system of claim 1 further comprising a microphone for capturing audio while the at least one service event is performed, the recording device being further configured to record the audio onto the electronic storage media.

12. The system of claim 1, wherein the recording device is disposed within the video camera.

13. A method of providing a service event on a customer vehicle in at least one vehicle service area, the at least one vehicle service area including at least one video camera, the at least one video camera being positioned with respect to the service area and the customer vehicle to capture images of the customer vehicle, the method comprising:
performing a service event on the customer vehicle;
while performing the service event, capturing images of the customer vehicle with the video camera;
receiving the captured images in a recording device;
recording the captured images onto a electronic storage media with the recording device; and
providing the electronic storage media to the customer.

14. The method of claim 13 further comprising:
providing a microphone within the at least one service area;
capturing audio on the microphone while the service event is performed;
receiving the audio in the recording device; and
recording the audio onto the electronic storage media with the recording device.

15. The method of claim 13 further comprising:
receiving the images from the video camera in a storage device;
storing the images in memory of the storage device; and
transmitting the images from the storage device to the recording device.

16. The method of claim 15 further comprising:
transmitting additional video features stored in the memory of the storage device to the recording device; and
recording the additional video features onto the electronic storage media.

17. The method of claim 15 further comprising editing the images received from the video camera before recording the images onto the electronic storage media.

18. The method of claim 13 further comprising receiving payment from the customer.
